(19) United States
(12) Patent Application Publication
(10) Pub. No.: US 2017/0258073 A1
(43) Pub. Date: Sep. 14, 2017

(54) REMOTE SOUND ACTIVATED MECHANICAL BIRD SYSTEM

(71) Applicant: Michael Lynders, Shelton, CT (US)

(72) Inventor: Michael Lynders, Shelton, CT (US)

(21) Appl. No.: 15/063,679

(22) Filed: Mar. 8, 2016

(51) Int. Cl. A01M 31/06; A01K 39/01; A01M 31/00; H04R 1/04

(52) U.S. Cl. CPC A01M 31/06; H04R 1/04; A01K 39/01; A01M 31/004; H04R 2420/07

(57) ABSTRACT

A remote sound activated mechanical bird system includes a bird feeder and a microphone mounted on the bird feeder. The microphone captures bird calls. A transmitter is electrically coupled to the microphone and transmits wireless signals including bird calls captured by the microphone. A bird assembly includes a body portion having an apex and bottom end. A head is rotatably mounted on the apex. A motor is mounted within the body portion. An axle is coupled to the motor and to the head so that the motor rotates the head when the motor is actuated. A receiving assembly is electrically coupled to the motor and receives wireless signals from the transmitter. The receiving assembly actuates the motor to turn the head when the receiving assembly receives the wireless signal which includes the bird calls. A sound emitter is electrically coupled to the receiving assembly to emit the bird calls.

### BACKGROUND OF THE DISCLOSURE

### Field of the Disclosure

The disclosure relates to mechanical bird assemblies and more particularly pertains to a new mechanical bird assembly for receiving and emitting remote bird vocalizations while providing mechanical movement of a representation of a bird.

### SUMMARY OF THE DISCLOSURE

An embodiment of the disclosure meets the needs presented above by generally comprising a bird feeder and a microphone mounted on the bird feeder. The microphone is configured to capture bird calls. A transmitter is electrically coupled to the microphone and transmits wireless signals including bird calls captured by the microphone. A bird assembly includes a body portion having an apex and bottom end. A head is rotatably mounted on the apex. A motor is mounted within the body portion. An axle is coupled to the motor and to the head so that the motor rotates the head when the motor is actuated. A receiving assembly is electrically coupled to the motor and receives wireless signals from the transmitter. The receiving assembly actuates the motor to turn the head when the receiving assembly receives the wireless signal which includes the bird calls. A sound emitter is electrically coupled to the receiving assembly to emit the bird calls captured by the microphone and transmitted by the transmitter.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a side view of a remote sound activated mechanical bird system according to an embodiment of the disclosure.

FIG. 2 is a top perspective view of a bird assembly of an embodiment of the disclosure.

FIG. 3 is a front view of the bird assembly of an embodiment of the disclosure.

FIG. 4 is a bottom view of a base of an embodiment of the disclosure.

FIG. 5 is an exploded perspective view of a bird feeder of an embodiment of the disclosure.

FIG. 6 is a top exploded view of an embodiment of the disclosure.

FIG. 7 is a side exploded view of an embodiment of the disclosure.

FIG. 8 is a rear exploded view of an embodiment of the disclosure.

FIG. 9 is a rear perspective exploded view of an embodiment of the disclosure.

FIG. 10 is an exploded perspective view of a base of an embodiment of the disclosure.

FIG. 11 is a schematic view of an embodiment of the disclosure.

### DESCRIPTION OF THE PREFERRED EMBODIMENT

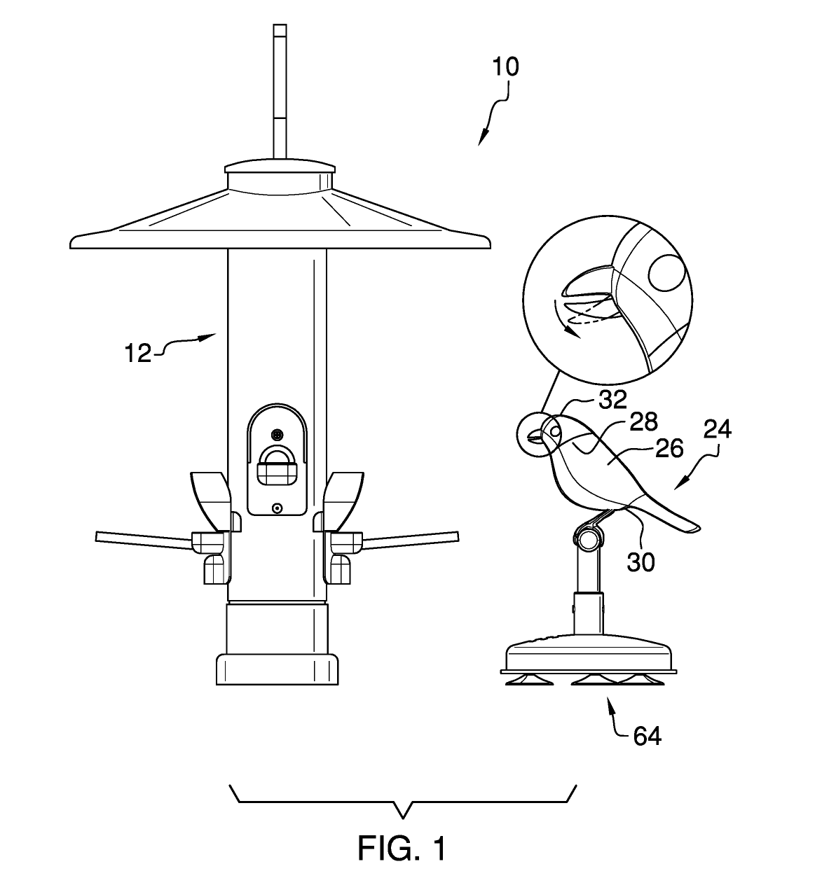

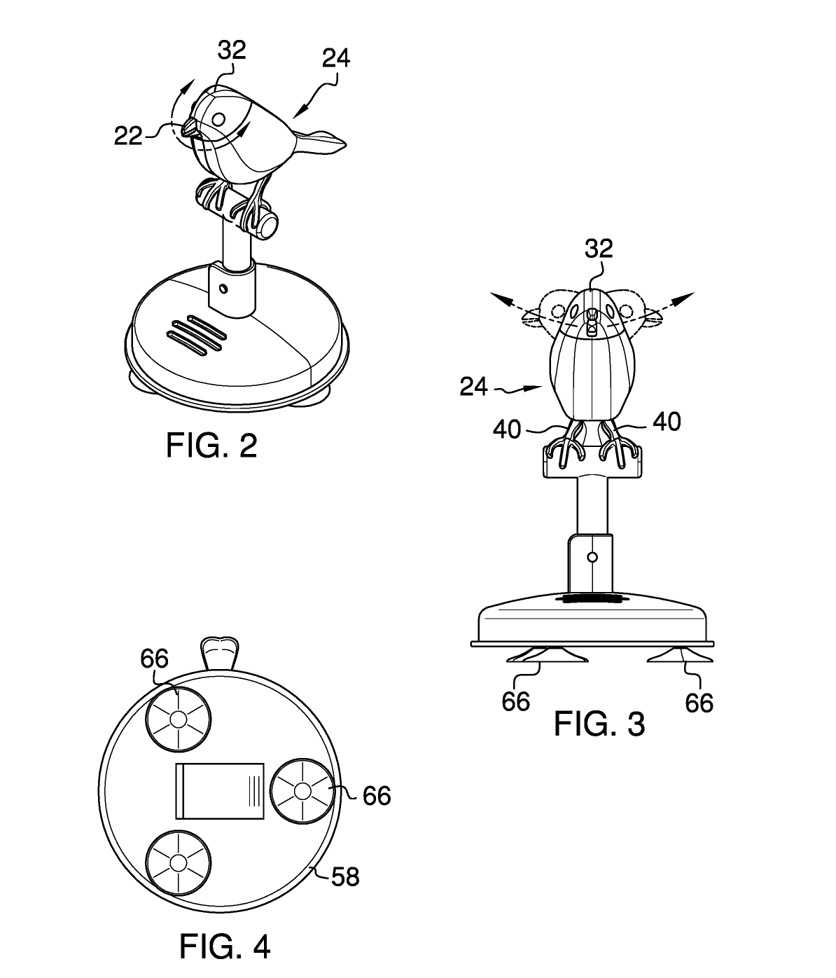

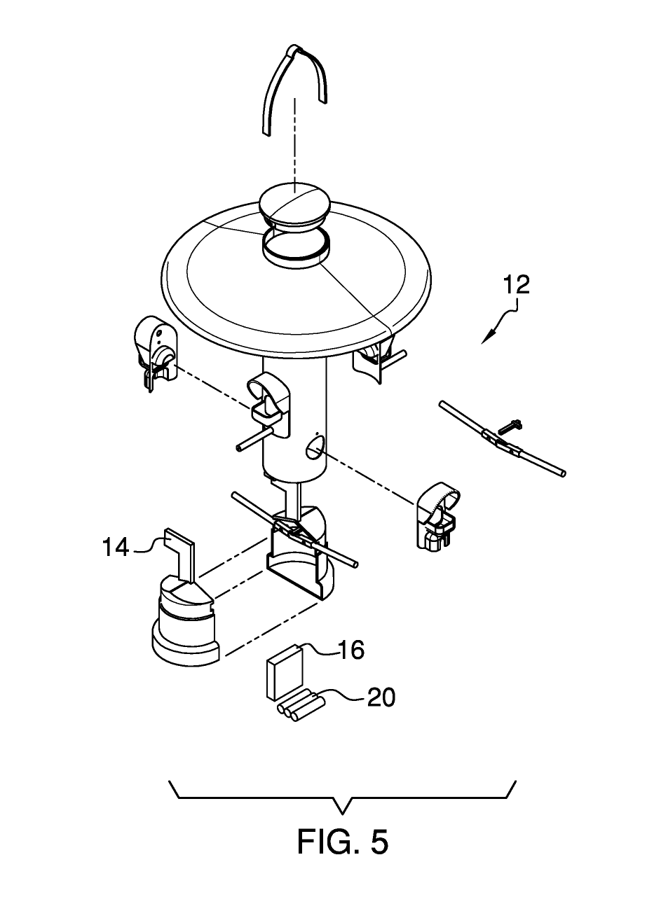

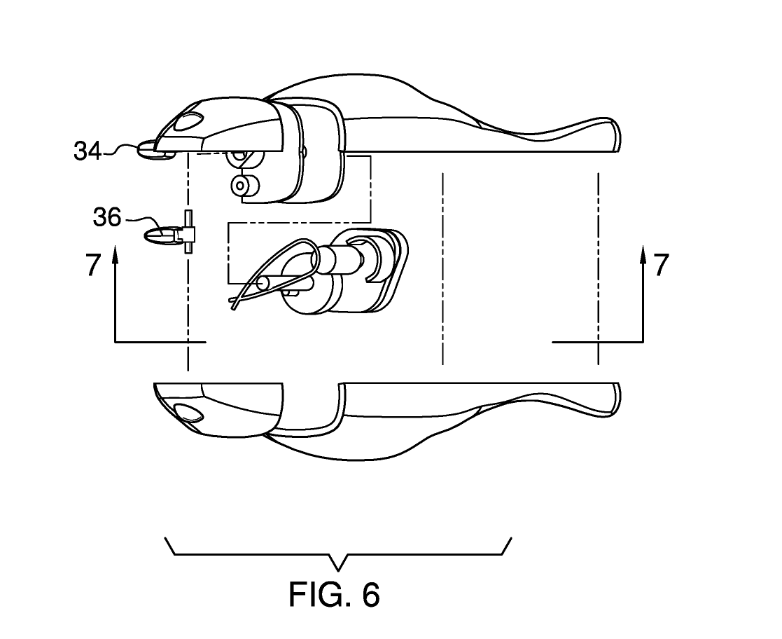

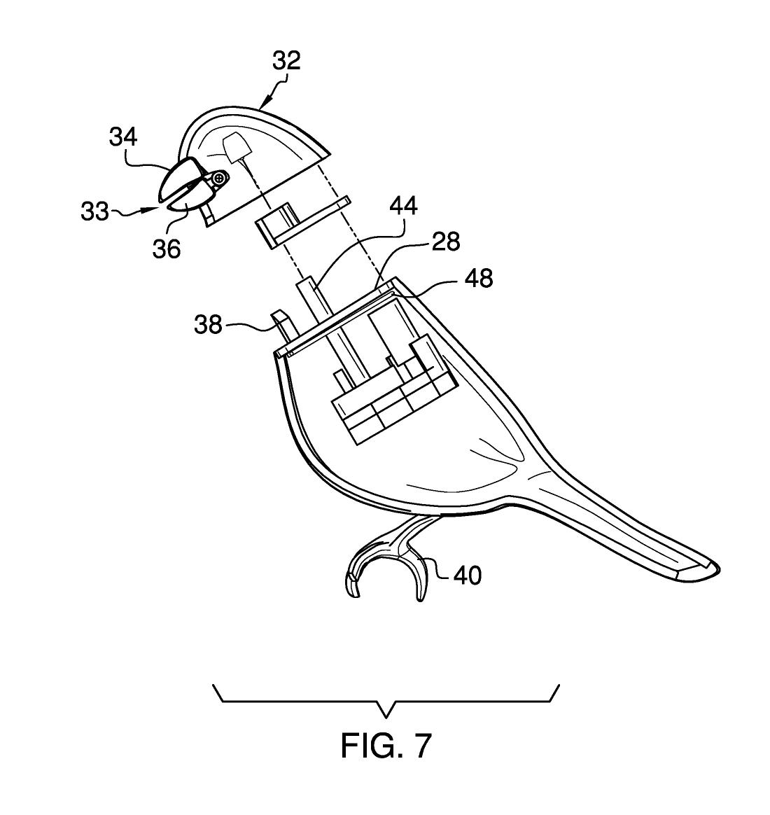

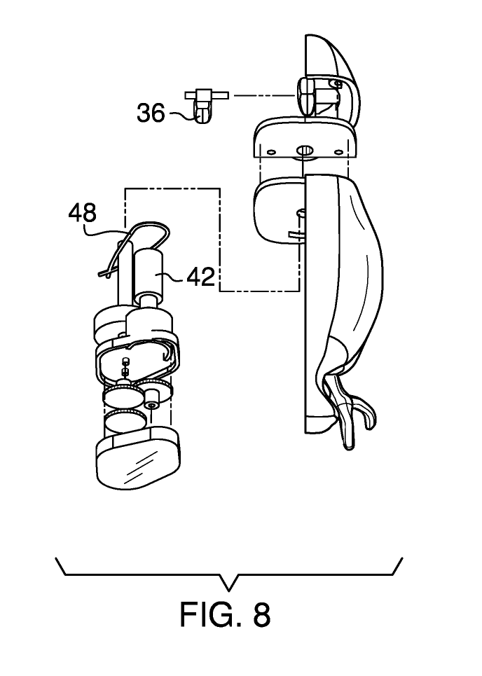

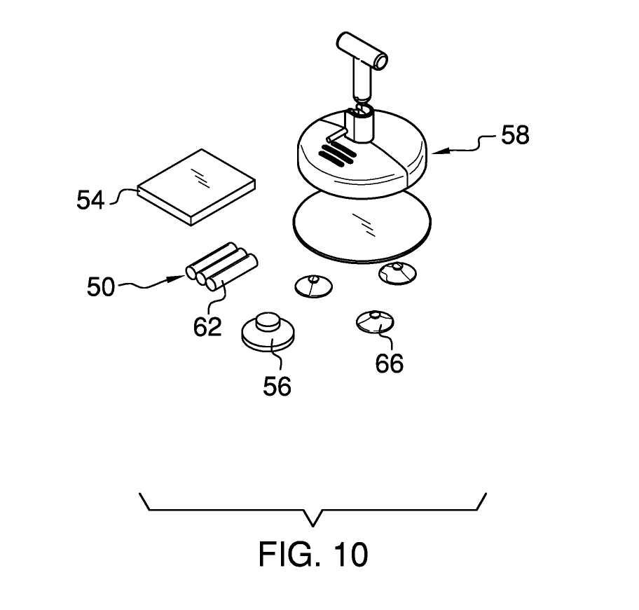

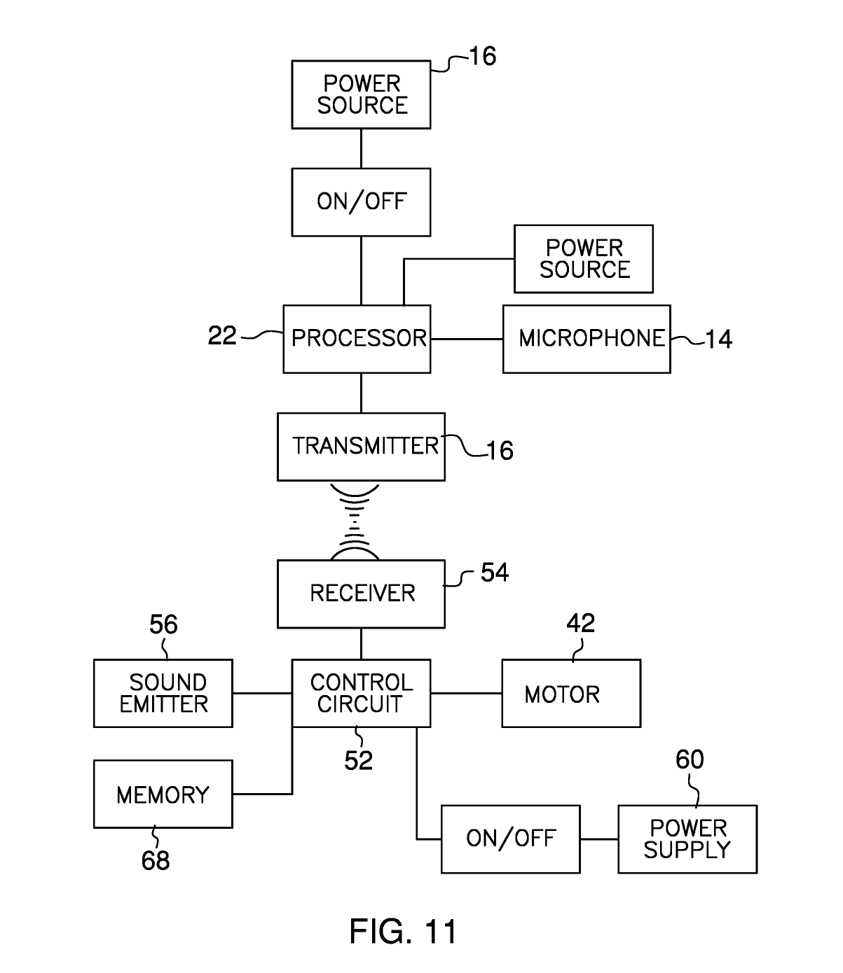

With reference now to the drawings, and in particular to FIGS. 1 through 11 thereof, a new mechanical bird assembly embodying the principles and concepts of an embodiment of the disclosure and generally designated by the reference numeral 10 will be described.

As best illustrated in FIGS. 1 through 11, the remote sound activated mechanical bird system 10 generally comprises a bird feeder 12. The bird feeder 12 is generally conventional and may comprise any such device capable of receiving bird seed. The bird feeder 12 may include multiple openings for accessing feed and a plurality of perches. A microphone 14 is mounted on the bird feeder 12. The microphone 14 is configured to capture sounds adjacent to the bird feeder 12 and in particular bird calls. The microphone 14 is mounted on the bird feeder 12. A transmitter 16 is electrically coupled to the microphone 14 and is configured to transmit wireless signals including bird calls captured by the microphone 14. A power source 18, such as one or more batteries 20, may be electrically coupled to the transmitter 16. A processor 22 may be in electrical communication with the microphone 14 and transmitter 16 and programmed to only transmit wireless signal when sound captured by the microphone 14 matches known bird calls.

A bird assembly 24 is provided which includes a body portion 26 having an apex 28 and bottom end 30. A head 32 is rotatably mounted on the apex 28. A beak 33 is attached to the head 32 and may include an upper portion 34 and a lower portion 36. The upper portion 34 is fixed with respect to the head 32 while the lower portion 36 is pivotally coupled to the head 32. The lower portion 36 is movable between a closed position and an open position. In one embodiment, the lower portion 36 may be moved to the open position by gravity. In such an embodiment, a nub 38 is mounted in the body portion 26 which alternatingly engages and disengages the lower portion 36 when the head 32 rotates. The lower portion 36 is in the open position when the nub 38 is disengaged with the lower portion 36 and is in the closed position when the nub 38 engages the lower portion 36. For example, as the head 32 rotates back and forth over the nub 38, the beak 33 opens and closes. A pair of legs 40 is attached to and extends downwardly from the bottom end 30. Alternatively, a solenoid or other mechanically driven device may be utilized to open and close the beak 32.

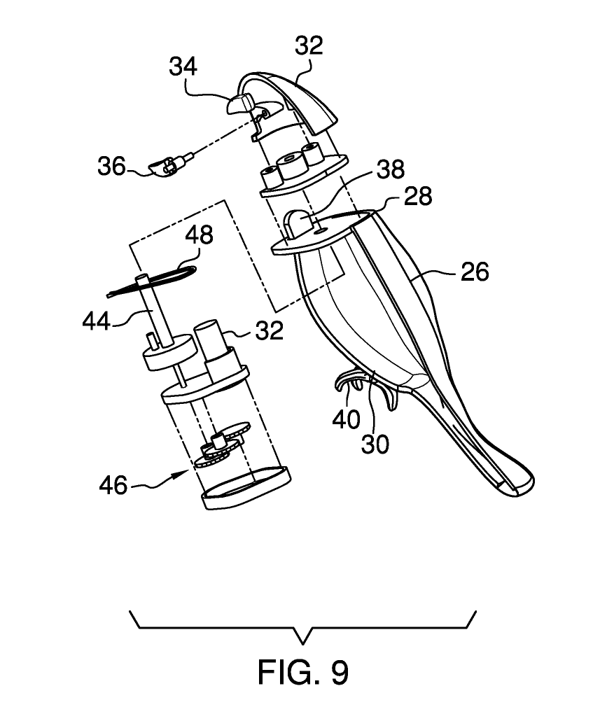

A motor 42 is mounted within the body portion 26. An axle 44 is coupled to the motor 44 and to the head 32, wherein the motor 42 may be mechanically engaged to the axle 44 by a plurality of gears 46. As can be seen in FIG. 9, the axle 44 may be the structure which mounts the head 32 to the body portion 26. The motor 42 rotates the head 32 when the motor 42 is actuated. A spring 48 is mounted to the axle 44 and biases the head 32 to a start position and may be used to restrict rotation of the head 32 such that the head 32 does not rotate greater than 180° with respect to the body portion 26.

A receiving assembly 50 is electrically coupled to the motor 42. The receiver assembly 50 is configured to receive wireless signals from the transmitter 16. The receiving assembly 50 actuates the motor 42 to turn the head 32 when the receiving assembly 50 receives the wireless signal including the bird calls. The receiving assembly 50 includes a control circuit 52 that is electrically coupled to the motor 42. A receiver 54 is electrically coupled to the control circuit 52 and is configured to receive the wireless signal from the transmitter 16. A sound emitter 56 is electrically coupled to the receiving assembly 50 and emits the bird calls captured by the microphone 14 and transmitted by the transmitter 16. A base 58 is attached to the bird assembly 24 and may be formed into a perch. Portions of the system 10, such as the receiving assembly 50 and sound emitter 56 may be positioned within the base 58 as well as a power supply 60, such as one or more batteries 62. A mount 64 is attached to the base 58 and is configured to retain the base 58 on a surface. The mount 64 may comprise at least one suction cup 66. This will allow the base 58 to be mounted on horizontal or vertical surfaces. The bird assembly 24 may be pivotally coupled to the base 58 to allow the bird assembly 24 to be adjusted relative to the angle of the base 58. An electronic memory 68 may be provided having prerecorded bird vocalizations thereon which is electrically coupled to the control circuit 52 wherein the user of the system 10 may selectively turn on the bird assembly 24 such that the head 32 and beak 33 are moved while the prerecorded bird vocalizations are being audibly played on the sound emitter 56.

In use, the bird feeder 12 is used in a conventional manner to attract and feed birds. The bird assembly 24 and base 58 are placed within transmitting range of the transmitter 16 and typically placed within a dwelling. When the microphone 14 captures bird calls, those sounds are transmitted to the receiving assembly 50 which actuates the motor and audibly emits the bird calls with the sound emitter 56. Thus, the bird assembly 24 appears to be moving and making bird calls as one or more birds are vocalizing adjacent to the bird feeder 12. The system 10 may be activated when birds are detected as present. This may be achieved by pivotal coupling of bird perches such that a bird being supported on one of the bird perches pivots the bird perch to engage a leaf switch to activate the system 10. Alternatively, the presence of birds may be sensed in another conventional manner such as a passive infra red motion sensor or the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A bird mimicking system comprising:
a bird feeder;
a microphone being mounted on said bird feeder, said microphone being configured to capture bird calls;
a transmitter being electrically coupled to said microphone and being configured to transmit wireless signals including bird calls captured by said microphone;
a bird assembly including:
a body portion having an apex and bottom end;
a head being rotatably mounted on said apex;
a motor being mounted within said body portion, an axle being coupled to said motor and to said head, said motor rotating said head when said motor is actuated;
a receiving assembly being electrically coupled to said motor, said receiver assembly being configured to receive wireless signals from said transmitter, said receiving assembly actuating said motor to turn said head when said receiving assembly receives said wireless signal including the bird calls; and
a sound emitter being electrically coupled to said receiving assembly, said sound emitter emitting the bird calls captured by said microphone and transmitted by said transmitter.

2. The bird mimicking system according to claim 1, wherein said bird assembly further includes a beak being attached to said head, said beak including an upper portion and a lower portion, said upper portion being fixed with respect to said head, said lower portion being pivotally coupled to said head, said lower portion being movable between a closed position and an open position.

3. The bird mimicking system according to claim 2, further including a nub being mounted in said body portion, said nub alternatively engaging and disengaging said lower portion when said head rotates, said lower portion being in said open position when said nub is disengaged with said lower portion and being in said closed position when said nub engages said lower portion.

4. The bird mimicking system according to claim 1, further including a pair of legs being attached to and extending downwardly from said bottom end.

5. The bird mimicking system according to claim 1, further including a spring being mounted to said axle and biasing said head to a start position.

6. The bird mimicking system according to claim 1, wherein said receiving assembly includes:
a control circuit being electrically coupled to said motor; and
a receiver being electrically coupled to said control circuit and being configured to receive the wireless signal from said transmitter.

7. The bird mimicking system according to claim 1, further including a base being attached to said bird assembly, a mount being attached to said base and being configured to retain said base on a surface.

8. The bird mimicking system according to claim 7, wherein said mount comprises at least one suction cup.

9. A bird mimicking system comprising:
a bird feeder;
a microphone being mounted on said bird feeder, said microphone being configured to capture bird calls;
a transmitter being electrically coupled to said microphone and being configured to transmit wireless signals including bird calls captured by said microphone;
a bird assembly including:
a body portion having an apex and bottom end;
a head being rotatably mounted on said apex;
a beak being attached to said head, said beak including an upper portion and a lower portion, said upper portion being fixed with respect to said head, said lower portion being pivotally coupled to said head, said lower portion being movable between a closed position and an open position, a nub being mounted in said body portion, said nub alternatively engaging and disengaging said lower portion when said head rotates, said lower portion being in said open position when said nub is disengaged with said lower portion and being in said closed position when said nub engages said lower portion;
a pair of legs being attached to and extending downwardly from said bottom end;
a motor being mounted within said body portion, an axle being coupled to said motor and to said head, said motor rotating said head when said motor is actuated, a spring being mounted to said axle and biasing said head to a start position;
a receiving assembly being electrically coupled to said motor, said receiver assembly being configured to receive wireless signals from said transmitter, said receiving assembly actuating said motor to turn said head when said receiving assembly receives said wireless signal including the bird calls, said receiving assembly including:
a control circuit being electrically coupled to said motor;
a receiver being electrically coupled to said control circuit and being configured to receive the wireless signal from said transmitter;
a sound emitter being electrically coupled to said receiving assembly, said sound emitter emitting the bird calls captured by said microphone and transmitted by said transmitter; and
a base being attached to said bird assembly, a mount being attached to said base and being configured to retain said base on a surface, said mount comprising at least one suction cup.
